(19) United States
(12) Patent Application Publication
(10) Pub. No.: US 2017/0262859 A1
(43) Pub. Date: Sep. 14, 2017

(54) METHOD AND SYSTEM FOR PROVIDING IT SUPPORT, BUILDING AND MANAGING NETWORK INFRASTRUCTURES ON DEMAND

(71) Applicant: HecTech, Inc., Santa Monica, CA (US)

(72) Inventor: Wesley SAINT LOUIS, Los Angeles, CA (US)

(21) Appl. No.: 15/450,025

(22) Filed: Mar. 6, 2017

Related U.S. Application Data
(60) Provisional application No. 62/305,522, filed on Mar. 8, 2016.

(51) Int. Cl. G06Q 30/00; G06Q 10/06; G06Q 20/10; G06Q 10/10; G06Q 30/06

(52) U.S. Cl. CPC G06Q 30/016; G06Q 10/1095; G06Q 30/0613; G06Q 20/102; G06Q 10/06311

(57) ABSTRACT

A computer-implemented method and system for providing IT support on demand. The computer-implemented method includes presenting a chat session to the customer through a user interface thereby connecting a customer to a job evaluator to create a ticket. Further, the computer-implemented method includes sending a customer's job quote, the job quote includes a service order with a price estimate. Furthermore, the computer-implemented method includes allowing the customer to schedule an appointment with the job evaluator. Moreover, the computer-implemented method also includes establishing one of a remote support type and an onsite support type to the customer to solve one or more issues. The computer-implemented method includes permitting the customer to rate the job evaluator in response to completing the job, wherein a reduced rating initiates a new job evaluator to fix the one or more issues.

### TECHNICAL FIELD

Embodiments of the disclosure relate generally to IT services. Embodiments relate more particularly to provide a computer-implemented method to provide IT support on demand with a direct connection with professionals that provides IT services at anytime, anywhere.

### BACKGROUND

Technical Support is a service provided by a computer or a technological company for aiding or advising customers of its product or service by telephone or email. However, several companies may not afford certified expert engineers to solve the technology issues. Specifically, it becomes expensive for consumers to small business to afford an IT department or even afford the services of a managed services consultancy firm. Further, with the advancement and complexities of technology, consumers to small business are only provided with “Tech support” solutions from various companies, such as Geek Squad, Hello Tech and Apple's Genius Bar. Moreover, there is no real support provided for the new virtual, work from home or remote office workforce.

With the onset of new technologies such as Internet of Things (IoT), there is no reliable support service provider with the proven advance skill sets that is affordable to the consumer to small business. However, as today is a mobile app dominated world, consumers are still left with the options of calling or visiting a support service provider's website to receive support. Traditionally, consumers have to schedule a support appointment and often times have to go to the support provider location to get technical support. However, the technical support is not on demand. Further, when a consumer is connected with a tech over the phone, the tech happens to read from a script aka knowledge base.

Typically, consumers to small business have support engineers to resolve issues during business hours. However, at times consumers require support engineers to be available after business hours as well. The support engineers may not be user friendly. Additionally, when consumers get connected to a support engineer, the consumers need to explain the issue to several people. There is no active log or documentation of the customer's problem. Further, if the issue reoccurs, the consumers are charged again to resolve the same issue.

Currently, there are several solutions that are available to overcome the above-mentioned problems. For instance, consumers may Google search a nearby support service company. However, there is no guarantee that the technicians would be skilled enough to resolve the issue. Consumers need to schedule an appointment during business hours and wait in line for their turn.

In the light of the above discussion, there appears to be a need to provide technical support on demand.

### OBJECTIVE OF INVENTION

The principal objective of the embodiments herein is to provide IT support on demand. The method described herein allows consumers to have direct connection with professionals who provide IT services at anytime and anywhere.

Another objective of the embodiments herein is to provide services such as “On Demand Technology Support”, “Gizmo Store (Procurement)”, “Network in a Box (NIAB)”.

Another objective of the embodiments herein is to make IT support simple, fast, and reliable to consumers.

### SUMMARY

The above-mentioned needs are met by a computer-implemented method, a computer program product and a system for providing IT support on demand.

An example of a computer-implemented method for providing IT support on demand includes presenting a chat session to the customer through a user interface thereby connecting a customer to a job evaluator to create a ticket. Further, the computer-implemented method includes sending a customer's job quote; the job quote includes a service order with a price estimate. Furthermore, the computer-implemented method includes allowing the customer to schedule an appointment with the job evaluator. Moreover, the computer-implemented method also includes establishing one of a remote support type and an onsite support type to the customer to solve one or more issues. The computer-implemented method includes permitting the customer to rate the job evaluator in response to completing the job, wherein a reduced rating initiates a new job evaluator to fix the one or more issues.

An example of a computer program product for providing IT support on demand includes presenting a chat session to the customer through a user interface thereby connecting a customer to a job evaluator to create a ticket. Further, the computer program product includes sending a customer's job quote; the job quote includes a service order with a price estimate. Furthermore, the computer program product includes allowing the customer to schedule an appointment with the job evaluator. Moreover, the computer program product also includes establishing one of a remote support type and an onsite support type to the customer to solve one or more issues. The computer program product includes permitting the customer to rate the job evaluator in response to completing the job, wherein a reduced rating initiates a new job evaluator to fix the one or more issues.

An example of a system for providing IT support on demand includes a computing device configured with an administrator portal. The system also includes a customer operating the computing device wherein the computing device encompasses one or more problems. Further, the system also includes a support engineer located in a remote location and is qualified to resolve IT related problems that the customer faces. Furthermore, the system includes a network. Moreover, the system includes a processor configured within the computing device and operable to perform: presenting a chat session to the customer through a user interface thereby connecting a customer to a job evaluator to create a ticket; sending a customer's job quote, the job quote includes a service order with a price estimate; allowing the customer to schedule an appointment with the job evaluator; establishing one of a remote support type and an onsite support type to the customer to solve one or more issues; permitting the customer to rate the job evaluator in response to completing the job, wherein a reduced rating initiates a new job evaluator to fix the one or more issues.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the environment, according to the embodiments as disclosed herein;

FIG. 2 is a flow chart describing a computer-implemented method for providing IT support on demand to customers, according to the embodiments as disclosed herein;

FIG. 3a-FIG. 3d is a flow chart describing an application process, according to the embodiments as disclosed herein;

FIG. 4a-FIG. 4d is a flow chart describing a support process, according to the embodiments as disclosed herein;

FIG. 5a-FIG. 5i are exemplary screenshots of the computer-implemented method, according to the embodiments as disclosed herein;

FIG. 6 illustrates the steps to create support ticket, according to the embodiments as disclosed herein;

FIG. 7 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a computer-implemented method and system for providing IT support on demand. The following detailed description is intended to provide example implementations to one of ordinary skill in the art, and is not intended to limit the invention to the explicit disclosure, as one or ordinary skill in the art will understand that variations can be substituted that are within the scope of the invention as described.

It will be appreciated to those skilled in the art that the terms “support engineer”, “IT support”, “job evaluator” and “community engineer” may be interchangeable used throughout the description herein.

### System Block Diagram

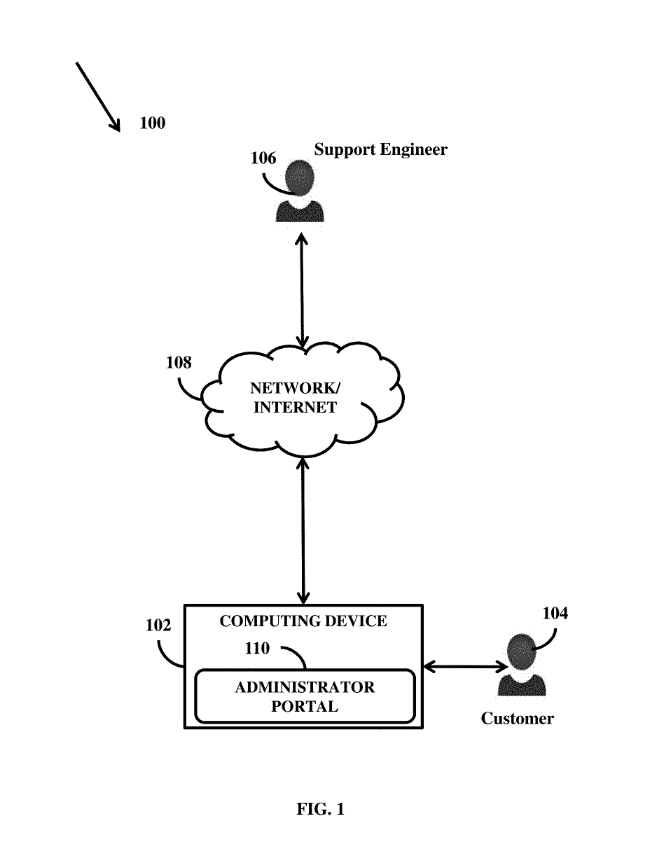

FIG. 1 is a block diagram of the environment, according to the embodiments as disclosed herein. As depicted in FIG. 1, the components of the environment 100 include a customer 102, a computing device 104, a support engineer 106 and a network 108. The computing device 104 is further configured with an administrator portal 110.

A computer program product (herein referred to as “HecTech” mobile application) is tangibly embodied in the computing device 104. The computer program product also contain instructions that when executed perform the method described herein. In a preferred embodiment, “Hectech” is configured on iPhone and Android devices.

The customer 102 is a person using “Hectech” on the mobile device 104. Examples of the computing device 104 includes, but is not limited to, personal digital assistants, cellular telephones, smart phones, tablets and other similar computing devices. Strictly speaking, the computing device 104 is encompasses one or more IT problem(s).

The administrator portal 110 of the “HecTech” application comprises of a master control panel and provides the following features:
Master Email Login ID
Add and manage IT contractors and profiles
Manage customer service records using a Ticketing System
Payment Management
User management
User analytic tracking
Engineer/Support staff

Further, the “HecTech” application provides the following features for the IT support staff:
Master Email Login ID
Add and manage IT Engineers and profiles
Manage customer service records using a Ticketing System
User management and Push Notification management
User analytic tracking
Dispatch notification

The support engineer 106 is a person who is located in a remote location and specifically is qualified to resolve IT related problems that the customer 102 faces. Typically, the remote location is a place situated far away or at a distant place from the director 102. The support engineer 106 also operates on a mobile device similar to the mobile device 104.

Network link(s) involved in the system of the present invention may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Blue-Tooth.

The customer 102 logs into the mobile application “HecTech” to resolve an IT problem. HecTech then provides a plurality of options to the customer 102. Typically, each of the options allows the customer with a specific support service. The services offered include “On Demand Technology Support”, “Gizmo Store (Procurement)”, and “Network in a box (NIAB)”. Once the support service is verified, a service order is generated with a price estimate to solve the IT problem. The service order is sent to the customer for approval. If the customer approves the service order, payment verification is performed. Subsequently, the service order is assigned to a support engineer 106. The support engineer 106 establishes either provides a remote support type or an on-site support type. As a result, the IT problem is solved. The customer is then requested to provide a feedback on the service provided.

### Operational Flow Chart

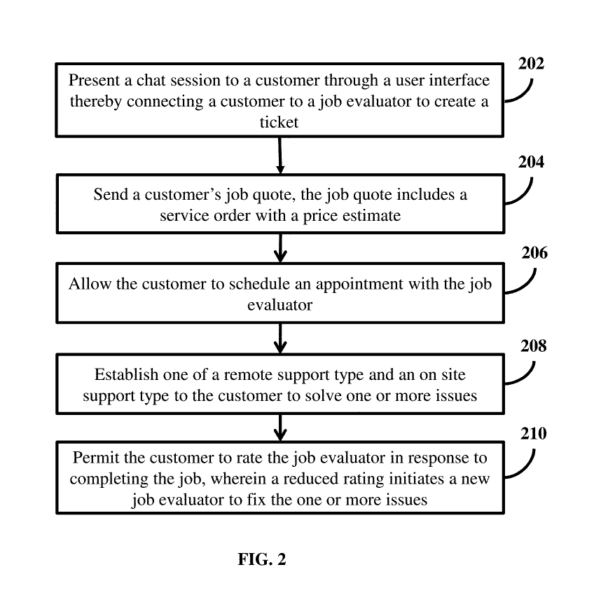

FIG. 2 is a flow chart describing a computer-implemented method for providing IT support on demand to customers, according to the embodiments as disclosed herein. The method begins at step 202.

Typically, the method described herein involves two people, the customer and support engineer.

A customer seeking for IT support for a device is permitted to login to an application configured to perform the method described herein (“HecTech”). The login process may be performed through a social network or as an email login (with password reset functionality).

Upon successful login, the customer is provided with several options. The options are as follows:
a. On Demand Technology Support
b. Network in a Box (NIAB)
c. Gizmo Store (Procurement)
d. “Build and Manage”
e. Master Email Login ID
f. User Profile
g. Support ticket log

Specifically, On Demand methodologies allow customers to get the desired services. On Demand methodologies is a popular enterprise model in which desired resources are made available to the user as needed. The resources may be maintained within the user's enterprise or made available by a service provider. In other words, On-Demand methodologies meet the customer's fluctuating demands efficiently.

When the customer selects “On Demand Technology Support” the following are performed:
1. The customer is allowed to create a support request and then submit that request to local service providers.
2. All the service providers (within close proximity to the customer), will submit their bid and the winning bid will get the job and access to connect with customer via the app.
3. Several additional “On Demand” features are accessible to both the customer and service provider.

“Network in a Box (NIAB)” is an all-inclusive service for successfully building small businesses' network infrastructure backbone, which is all offered at one discounted price. The customer may purchase this all-inclusive service in the app.

When the customer selects “Gizmo Store (Procurement)”, the following are preformed:
1. Customers can make purchases for technology devices and accessories within the app.
2. Customers also have the option to schedule a technician to setup, install and train them upon arrival of their product.

When the customer selects “Build and Manage” the following are performed:
1. The customer is directed to a screen which asks them to select the network type: Home, Small Office, Small Business (network types are based on number of users and devices).
2. The customer is presented with a fixed service cost estimate and must accept before being connected with a HecTech Engineer or Community Admin.
3. After accepting, the user is connect immediately with the Community Admin and or Community Engineer via live video conferencing to conduct a site assessment.
4. When the site assessment is scheduled the customer's credit card will be verified in the background.
5. During the site assessment the engineer will gather information about the space and the customer's needs. The engineer will go over the requirements as it relates to procurement and basic prerequisites. The engineer may advise the customer to upgrade their package if it is within the customer's interest.
6. After all the prerequisites are met along with the procurement of suggested equipment, the engineer sets up the network, test connectivity and communication among all devices, and train the customer on proper use and best practices.
7. The engineer documents steps taken to resolve the problem as well make notes on any recommendations and or discoveries during his visit. From the HecTech mobile app He/she then resolves the ticket which then brings up a signature approval page for customer to sign. At which point the customer's credit card will be charged.
8. Both the customer and Engineer will receive survey on their devices asking them to rate each other.
9. Five (5) days later the customer will receive a follow up call from a HecTech Community Administrator to check up and provide any feedback to the customer as it relates to wellness of their network. Tech support is included in this package; an engineer will be dispatched to resolve any issues as the needed.
10. The application uses various tools to solve the IT problems like in-chat, in-app incognito calls, in-app live video conferencing, ETA alerts, Engineer dispatch information, in-person meeting, or 3rd party tools where the user can download from a tool kit list.
11. The application tracks the user records using user analytics.

At step 202, a chat session is presented to a customer through a user interface thereby connecting a customer to a job evaluator to create a ticket.

At step 204, the customer's job quote is sent to the customer for approval. The job quote includes a service order with a price estimate. Typically, the support request is verified and is generated into the job quote (service order). Additionally, the customer may take a picture or a short video of the device problem and include it as a part of the request.

The customer may accept or reject the job quote. If the customer accepts the job quote, payment (credit card) verification is performed. Subsequently, a service order is assigned to a Community Engineer (CE).

At step 206, the customer is allowed to schedule an appointment with the job evaluator. Subsequently, a meeting is scheduled or a date is set for a service option. Appointment reminders are set through push notifications.

At step 208, one of a remote support type and an on-site support type is established with the customer to solve one or more issues.

The remote support type directs the customer to download remote support tools. In some embodiments, the support tools may be provided to the customer through a chat session.

The on-site support type directs the CE to the customer's location with the standard support kit. Here, the customer is updated constantly on the CE's approach.

At step 210, the customer is permitted to rate the job evaluator in response to completion of the job. The customer satisfaction review is sent once the CE completes the job. The customer is free to rate the CE as bad or good. If the rating is good, the customer signs off on work completed. Further, the customer's credit card is charged. The payment is then released to the CE minus 20%. On the other hand, if the rating is bad, “HecTech” Admin is alerted and a new CE is dispatched to fix the problem (if necessary). The CE is terminated from his/her service.

The CE also rates the client. The rating may be good or bad. In case of a bad rating, a red flag is placed on the customer's account.

Subsequent to the review process, the application “HecTech” tracks the user records using user analytics.

The method ends at step 210.

The method described herein is beneficial for several reasons such as the following:
1. It provides consumers with affordable IT solutions from certified expert engineers.
2. It provides consumers with true dedicated “On Demand” IT solutions that follow them anywhere they go anytime.
3. It enhances engagement.
4. It aids promotion.
5. It offers support thereby making it convenient for our consumers to have direct contact and connection to the support engineers.
6. It ensures ease.
7. It provides visibility to customers at all times.
8. It creates a direct marketing channel.
9. It provides value to customers.
10. It builds brand and recognition.
11. It improves customer engagement.
12. It cultivates customer loyalty.
13. It generates repeat business.
14. It enhances consumer's social networking strategies.

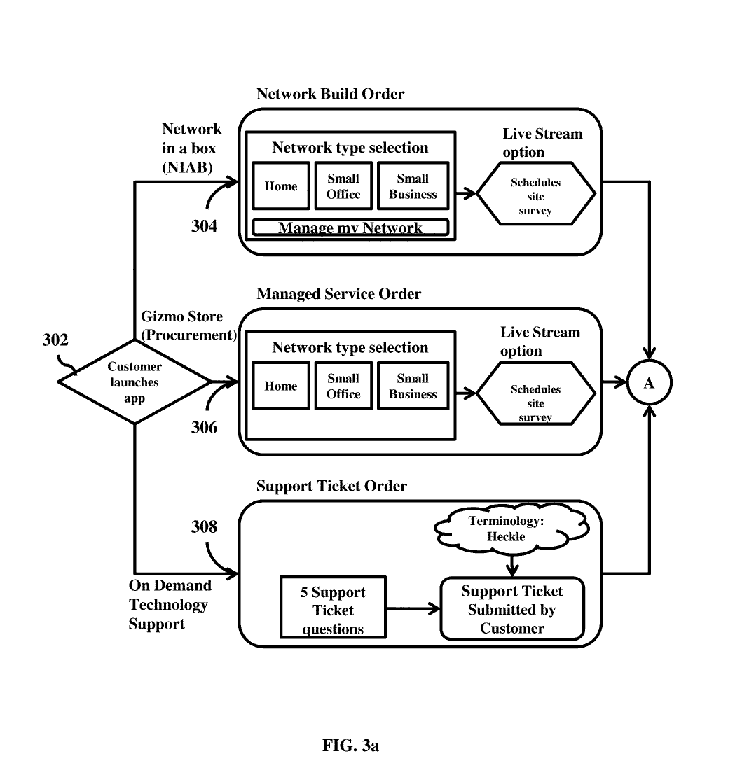

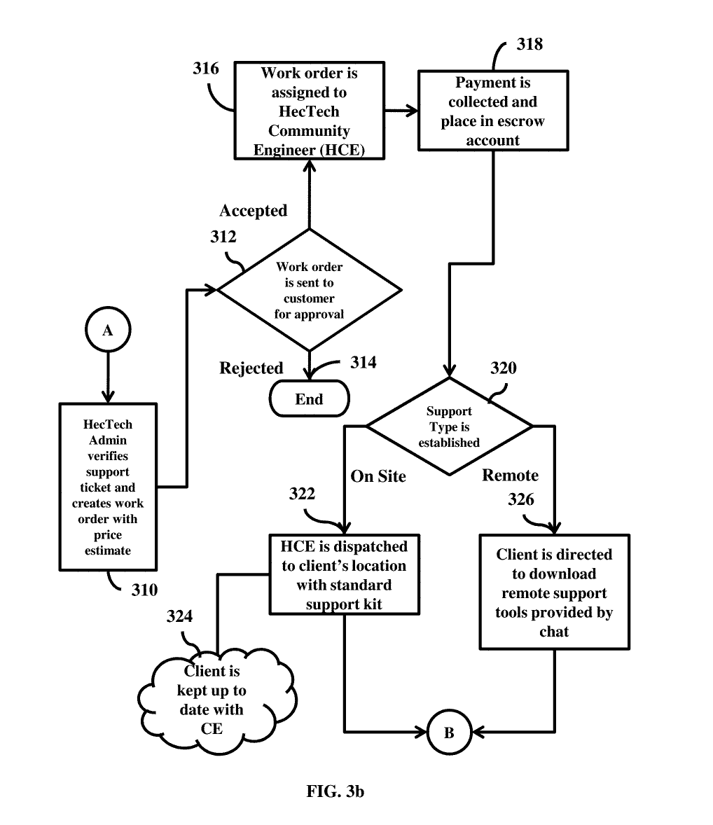

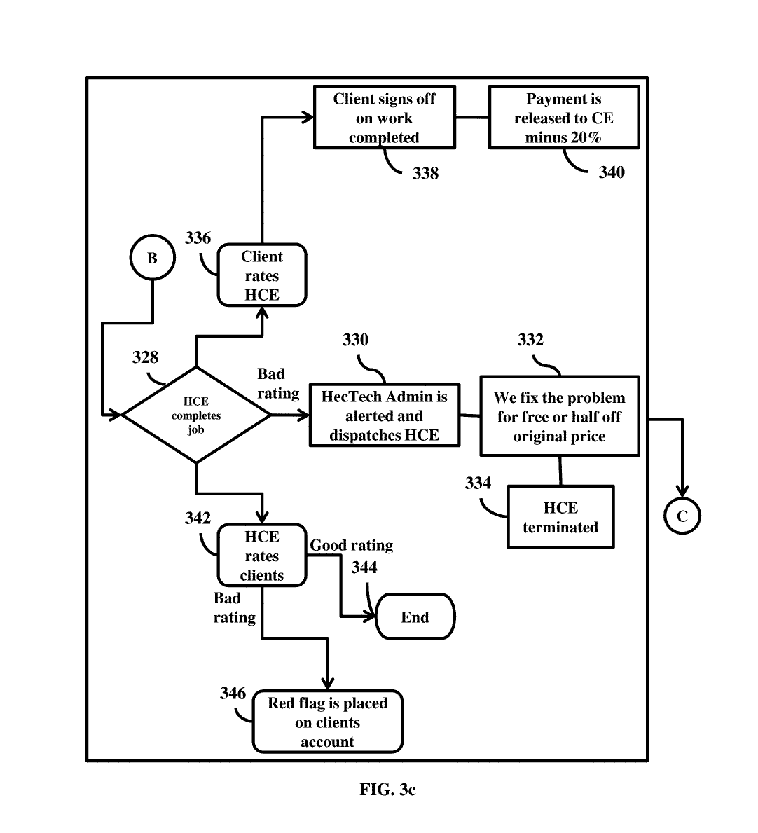

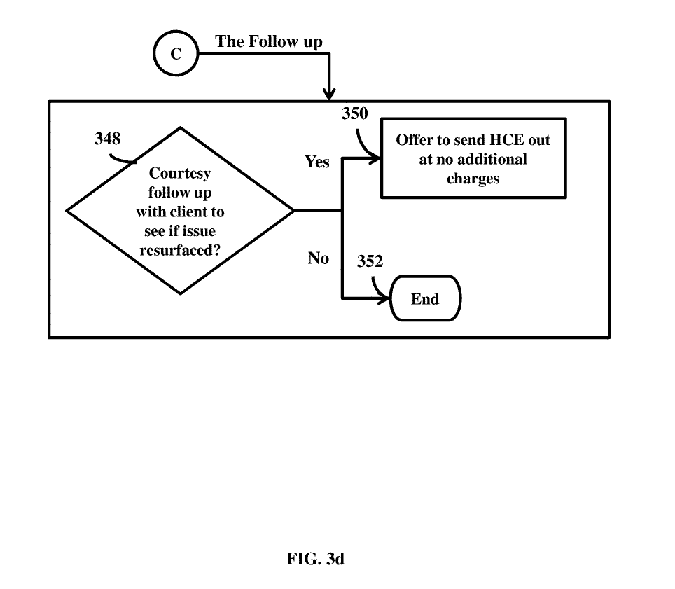

FIG. 3a-FIG. 3d is a flow chart describing an application process, according to the embodiments as disclosed herein. The flow chart begins at step 302.

At step 302, a customer launches the application that performs the method described herein. Subsequently, the customer may choose to perform step 304, step 306 or step 308.

At step 304, the customer chooses “Network in a box (NIAB)” option as described in paragraph [0014].

At step 306, the customer chooses “Gizmo Store (Procurement)” option as described in paragraph [0015].

At step 308, the customer chooses “On Demand Technology Support” option as mentioned in paragraph [0012].

Subsequent to step 304, step 306 and step 308, step 310 is performed.

At step 310, HecTech Admin verifies support ticket and creates work order with price estimate.

At step 312, work order is sent to the customer for approval. The customer may reject the work order at step 314. Alternatively, the customer may approve the work order at step 316.

At step 316, the work order is assigned to HecTech Community Engineer (HCE).

At step 318, payment is collected and placed in escrow account.

At step 320, a support type is established. Subsequently, step 322 or step 324 may be performed.

At step 322, an onsite support type is established. The HCE is dispatched to the client's location with standard support kit.

At step 324, the client is updated with the CE.

At step 326, the client is directed to download remote support tools provided by chat.

At step 328, HCE completes the job. Subsequently, step 330, step 342 or step 336 may be performed.

At step 330, in response to a bad rating, the HecTech Admin is alerted and a HCE is dispatched. At step 332, the problem is fixed for free or half off of the original price. At step 334, HCE is terminated.

At step 342, the HCE rates the client. If the rate is good, step 344 is performed. If the rate is bad, step 346 is performed. At step 344, the method ends. At step 346, a red flag is placed on clients account.

At step 336, the client rates HCE. At step 338, the client signs off on work completed. At step 340, payment is released to CE minus 20%.

At step 348, a follow up is performed. Specifically, a courtesy follow up is performed with the client to see if the issue has resurfaced. If the issue has resurfaced, step 350 is performed. Else step 352 is performed.

The flow chart ends at step 352.

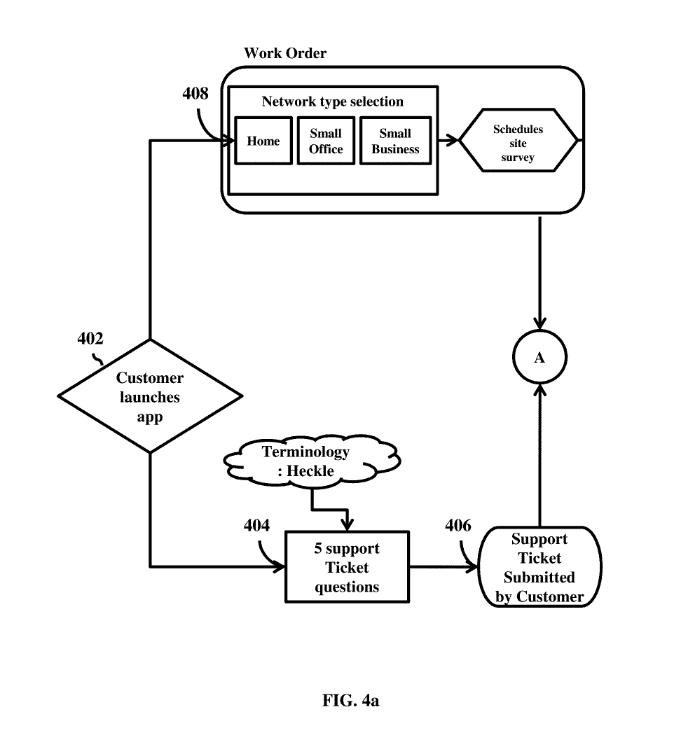

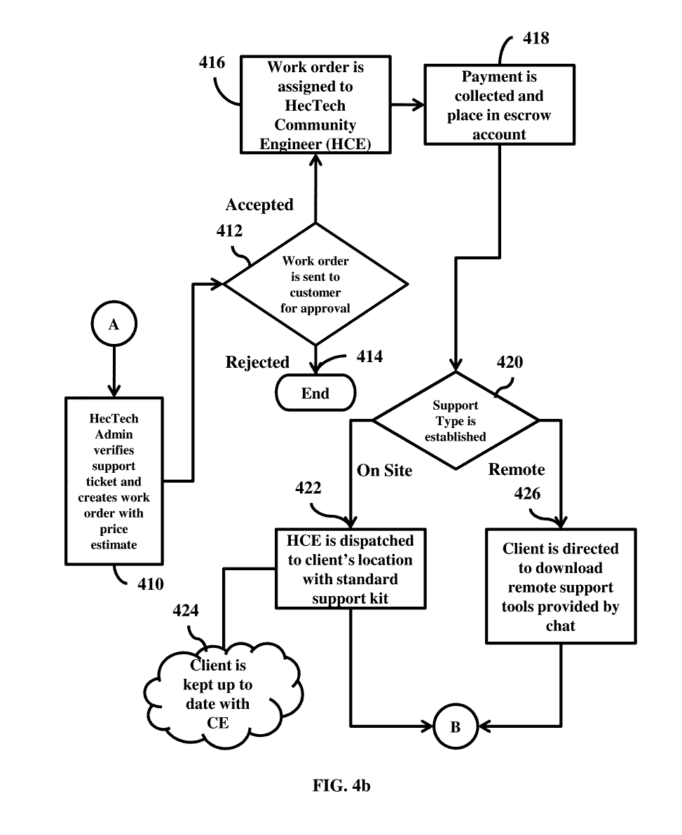

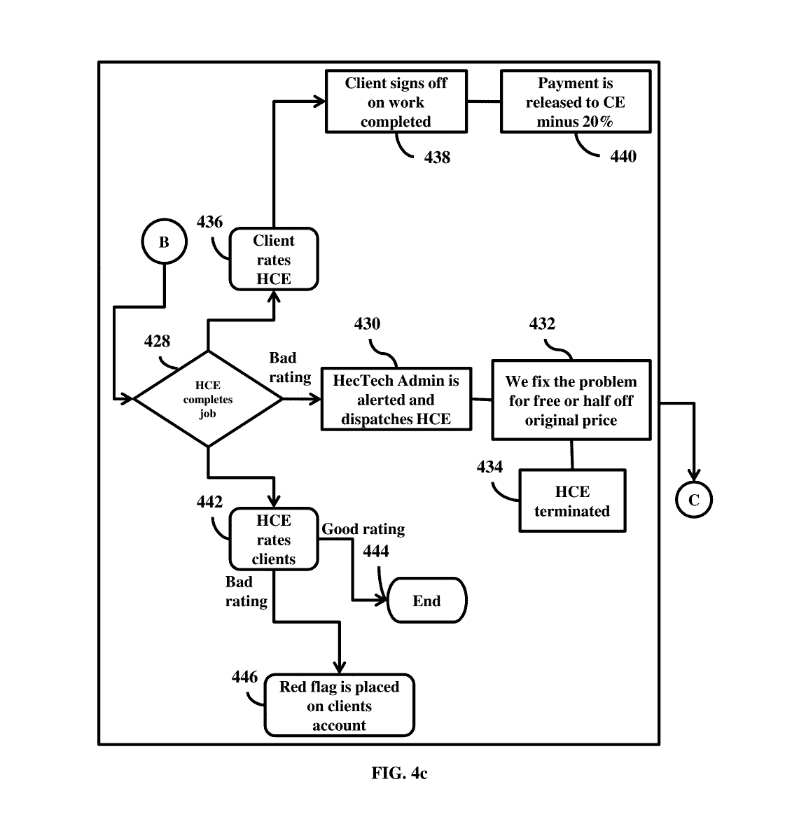

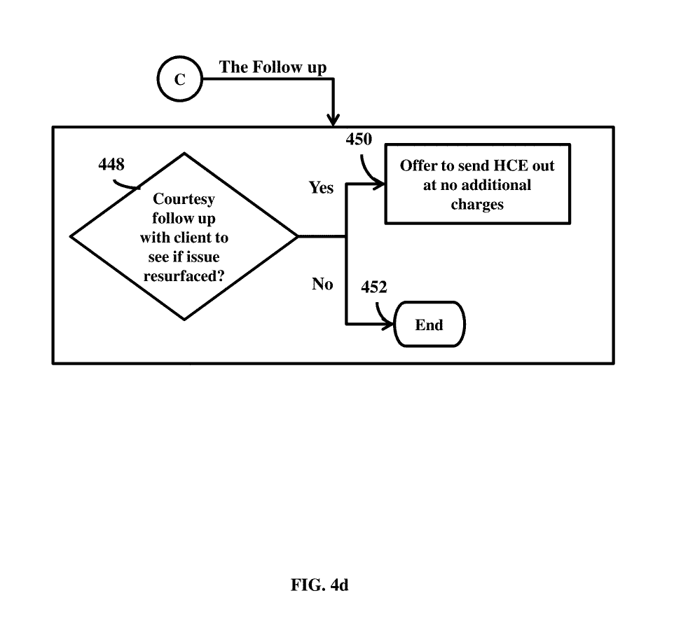

FIG. 4a-FIG. 4d is a flow chart describing a support process, according to the embodiments as disclosed herein. The flow chart begins at step 402.

At step 402, a customer launches the application that performs the method described herein. Subsequently, the customer may choose to perform step 404 or step 408.

At step 404, the customer chooses “Support Ticket Order” option as mentioned in paragraph [0012]. At step 406, the support ticket is submitted by the customer.

At step 408, the customer chooses “work order” option.

Subsequent to step 404 and step 408, step 410 is performed.

At step 410, HecTech Admin verifies support ticket and creates work order with price estimate.

At step 412, work order is sent to the customer for approval. The customer may reject the work order at step 414. Alternatively, the customer may approve the work order at step 416.

At step 416, the work order is assigned to HecTech Community Engineer (HCE).

At step 418, payment is collected and placed in escrow account.

At step 420, a support type is established. Subsequently, step 422 or step 424 may be performed.

At step 422, an onsite support type is established. The HCE is dispatched to the client's location with standard support kit.

At step 424, the client is updated with the CE.

At step 426, the client is directed to download remote support tools provided by chat.

At step 428, HCE completes the job. Subsequently, step 430, step 442 or step 436 may be performed.

At step 430, in response to a bad rating, the HecTech Admin is alerted and a HCE is dispatched. At step 432, the problem is fixed for free or half off of the original price. At step 434, HCE is terminated.

At step 442, the HCE rates the client. If the rate is good, step 444 is performed. If the rate is bad, step 446 is performed. At step 444, the method ends. At step 446, a red flag is placed on clients account.

At step 436, the client rates HCE. At step 438, the client signs off on work completed. At step 440, payment is released to CE minus 20%.

At step 448, a follow up is performed. Specifically, a courtesy follow up is performed with the client to see if the issue has resurfaced. If the issue has resurfaced, step 450 is performed. Else step 452 is performed.

The flow chart ends at step 452.

### Exemplary Screenshots

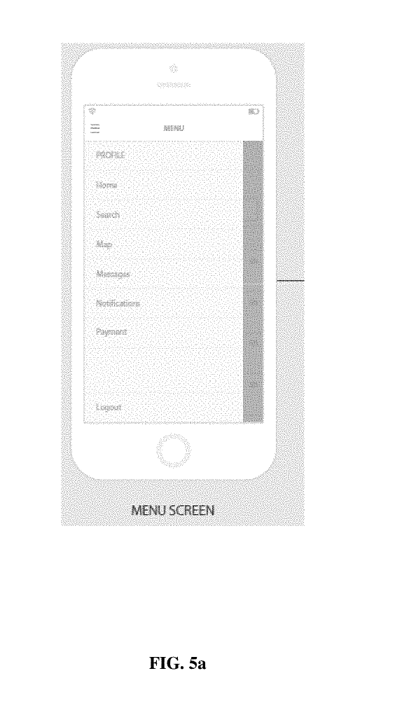

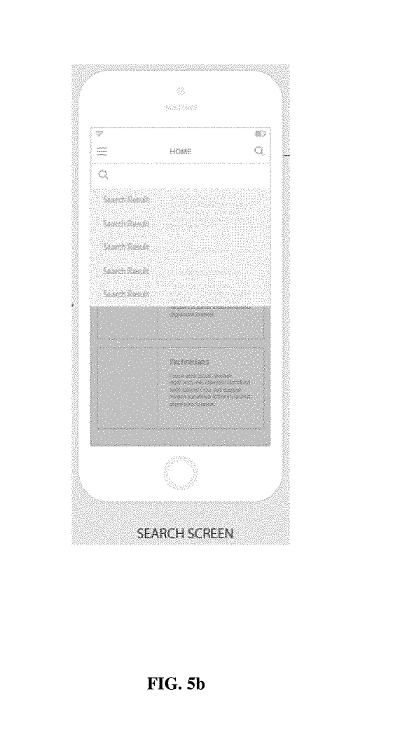

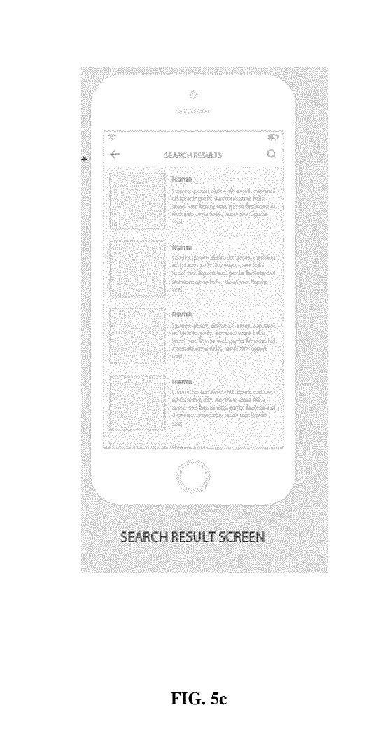

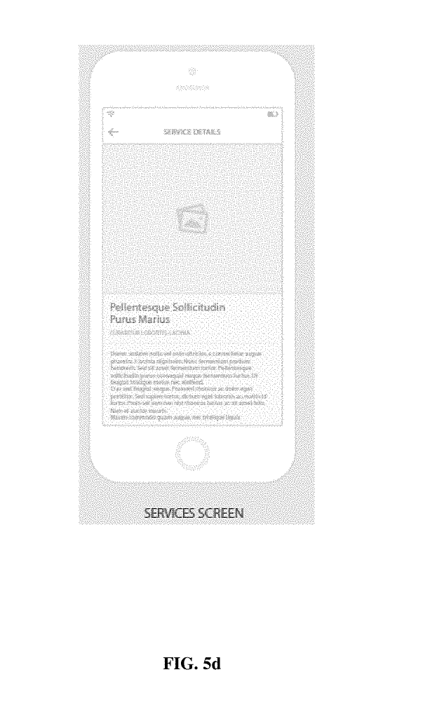

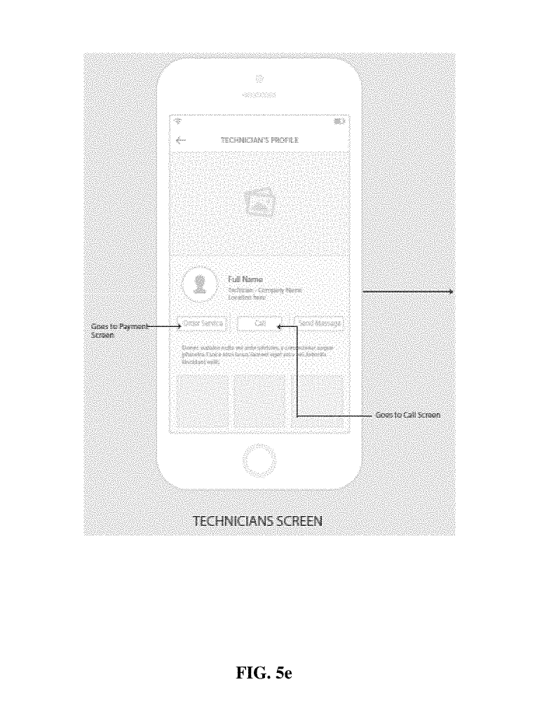

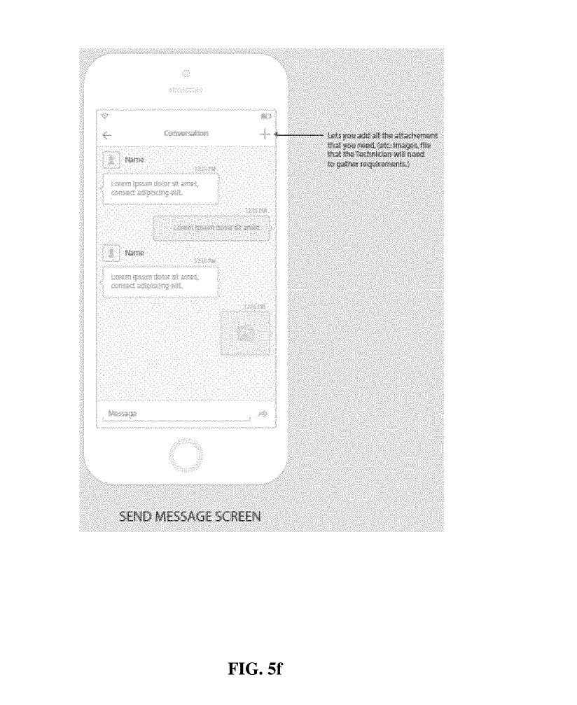

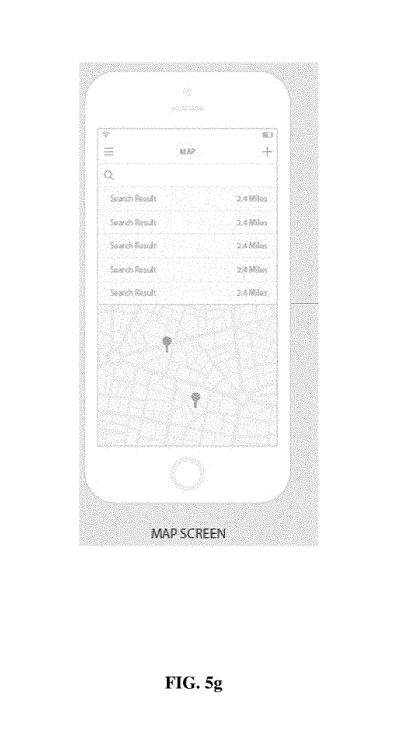

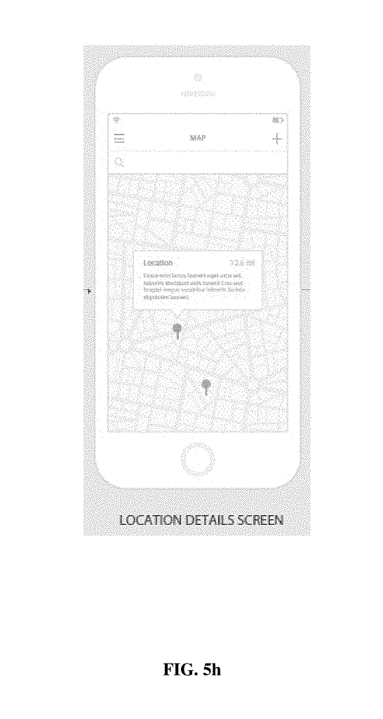

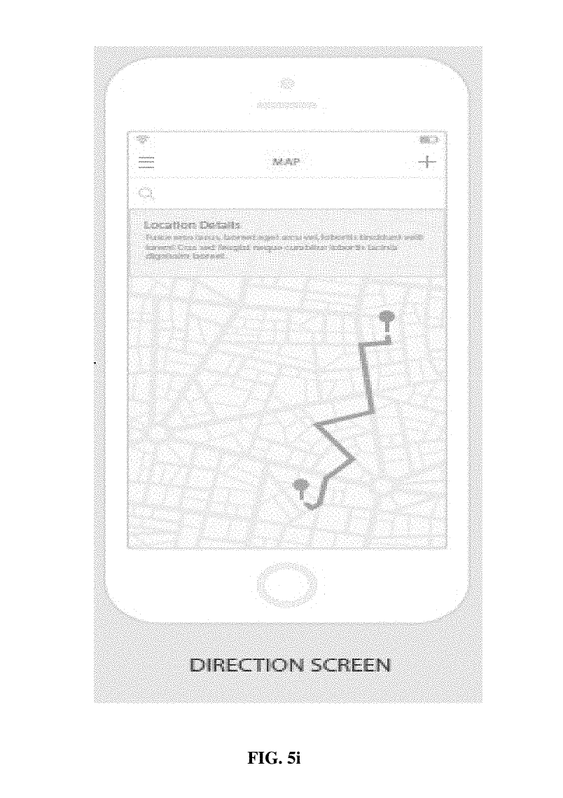

FIGS. 5a-5i are exemplary screenshots of the computer-implemented method, according to the embodiments as disclosed herein.

FIG. 5a is an exemplary screenshot of a menu screen of the application, according to the embodiments as disclosed herein.

FIG. 5b is an exemplary screenshot of a search screen of the application, according to the embodiments as disclosed herein.

FIG. 5c is an exemplary screenshot of a search result screen of the application, according to the embodiments as disclosed herein.

FIG. 5d is an exemplary screenshot of a services screen of the application, according to the embodiments as disclosed herein.

FIG. 5e is an exemplary screenshot of a technician's screen of the application, according to the embodiments as disclosed herein.

FIG. 5f is an exemplary screenshot of a send message screen of the application, according to the embodiments as disclosed herein.

FIG. 5g is an exemplary screenshot of a map screen of the application, according to the embodiments as disclosed herein.

FIG. 5h is an exemplary screenshot of a location details screen of the application, according to the embodiments as disclosed herein.

FIG. 5i is an exemplary screenshot of a direction screen of the application, according to the embodiments as disclosed herein.

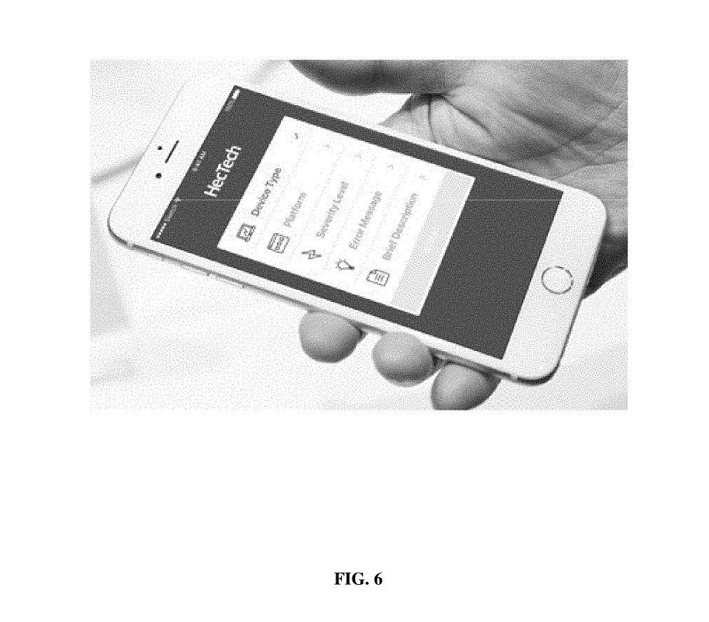

FIG. 6 illustrates the steps to create support ticket, according to the embodiments as disclosed herein.

### System Block Diagram

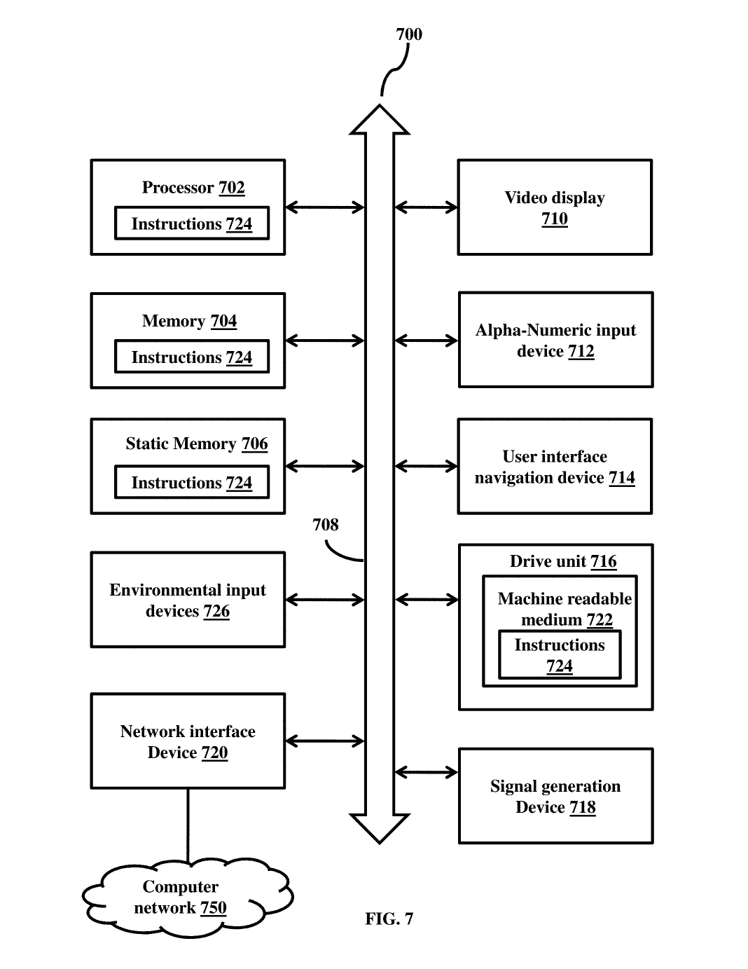

FIG. 7 is a block diagram of a machine in the example form of a computer system 700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker), and a network interface device 720. The computer system 700 may also include a environmental input device 726 that may provide a number of inputs describing the environment in which the computer system 700 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 724 may further be transmitted or received over a computer network 750 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A computer-implemented method for providing IT support on demand, the computer-implemented method comprises:
presenting a chat session to a customer through a user interface thereby connecting a customer to a job evaluator to create a ticket;
sending a customer's job quote, the job quote includes a service order with a price estimate;
allowing the customer to schedule an appointment with the job evaluator;
establishing one of a remote support type and an onsite support type to the customer to solve one or more issues; and
permitting the customer to rate the job evaluator in response to completing the job, wherein a reduced rating initiates a new job evaluator to fix the one or more issues.

2. The computer-implemented method of claim 1 and further comprising:
permitting a customer seeking for IT support to login to an application configured to perform the method described herein, wherein the customer requests for a support to perform a desired operation, wherein the operation is one of Network in a Box, Gizmo store and On-Demand technology support.

3. The computer-implemented method of claim 2 wherein the support request is verified and generated into the service order.

4. The computer-implemented method of claim 1 and further comprising:
permitting the customer to perform one of accepting and rejecting the job quote.

5. The computer-implemented method of claim 4 wherein accepting the job quote further comprises:
verifying the payment; and
assigning a service order to a community engineer.

6. The computer-implemented method of claim 1 wherein the remote support type directs the customer to download remote support tools and the on-site support type directs the CE to the customer's location with the standard support kit.

7. The computer-implemented method of claim 1 and further comprising:
permitting the job evaluator to rate the customer.

8. The computer-implemented method of claim 1 and further comprising:
setting appointment reminders through notifications.

9. The computer-implemented method of claim 1 and further comprising:
performing a follow-up with the customer to check resurfaced issues; and
tracking the user records using user analytics.

10. A computer program product stored on a non-transitory computer readable medium that when executed by a processor, performs a method for providing IT support on demand, the computer program product comprises:
presenting a chat session to a customer through a user interface thereby connecting a customer to a job evaluator to create a ticket;
sending a customer's job quote, the job quote includes a service order with a price estimate;
allowing the customer to schedule an appointment with the job evaluator;
establishing one of a remote support type and an onsite support type to the customer to solve one or more issues; and
permitting the customer to rate the job evaluator in response to completing the job, wherein a reduced rating initiates a new job evaluator to fix the one or more issues.

11. The computer program product of claim 10 and further comprising:
permitting a customer seeking for IT support to login to an application configured to perform the method described herein, wherein the customer requests for a support to perform a desired operation, wherein the operation is one of Network in a Box, Gizmo store and On-Demand technology support.

12. The computer program product of claim 11 wherein the support request is verified and generated into the service order.

13. The computer program product of claim 10 and further comprising:
permitting the customer to perform one of accepting and rejecting the job quote.

14. The computer program product of claim 13 wherein accepting the job quote further comprises:
verifying the payment; and
assigning a service order to a community engineer.

15. The computer program product of claim 10 wherein the remote support type directs the customer to download remote support tools and the on-site support type directs the CE to the customer's location with the standard support kit.

16. The computer program product of claim 10 and further comprising:
permitting the job evaluator to rate the customer.

17. The computer program product of claim 10 and further comprising:
setting appointment reminders through notifications.

18. The computer program product of claim 10 and further comprising:
performing a follow-up with the customer to check resurfaced issues; and
tracking the user records using user analytics.

19. A system for providing IT support on demand, the system comprises:
a computing device configured with an administrator portal;
a customer operating the computing device wherein the computing device encompasses one or more problems;
a support engineer located in a remote location and is qualified to resolve IT related problems that the customer faces;
a network; and
a processor configured within the computing device and operable to perform:
present a chat session to the customer through a user interface thereby connecting a customer to a job evaluator to create a ticket;
send a customer's job quote, the job quote includes a service order with a price estimate;
allow the customer to schedule an appointment with the job evaluator;
establish one of a remote support type and an onsite support type to the customer to solve one or more issues; and
permit the customer to rate the job evaluator in response to completing the job, wherein a reduced rating initiates a new job evaluator to fix the one or more issues.

20. The system of claim 19 wherein the administrator portal comprises a master control panel.
